(19) United States
(12) Patent Application Publication
(10) Pub. No.: US 2026/0343016 A1
(43) Pub. Date: Oct. 29, 2026

(54) AFFINE CANDIDATE REFINEMENT

(71) Applicant: MEDIATEK INC., Hsinchu City (TW)

(72) Inventors: Chih-Hsuan LO, Hsinchu City (TW); Chen-Yen LAI, Hsinchu City (TW); Chih-Wei HSU, Hsinchu City (TW); Tzu-Der CHUANG, Hsinchu City (TW); Ching-Yeh CHEN, Hsinchu City (TW)

(21) Appl. No.: 18/997,280

(22) PCT Filed: Jul. 18, 2023
(86) PCT No.: PCT/CN2023/107825

§ 371 Date: Jan. 21, 2025

Related U.S. Application Data
(60) Provisional application No. 63/369,083, filed on Jul. 22, 2022.
(60) Provisional application No. 63/369,094, filed on Jul. 22, 2022.
(60) Provisional application No. 63/478,198, filed on Jan. 3, 2023.

(51) Int. Cl. H04N 19/513; H04N 19/105; H04N 19/176

(52) U.S. Cl. CPC H04N 19/521; H04N 19/105; H04N 19/176

(57) ABSTRACT

A method for refining affine candidate by regression is provided. A video coder receives data for a block of pixels to be encoded or decoded as a current block of a current picture of a video. The video coder derives a linear model to refine a prediction candidate by regression to minimize a difference between samples of a current template neighboring the current block and samples of a reference template identified by the refined prediction candidate. The video coder generates a prediction of the current block based on the derived linear model. The video coder encodes or decodes the current block by using the generated prediction. The prediction candidate being refined may be an affine motion candidate and the derived linear model is an affine motion model.

### CROSS REFERENCE TO RELATED PATENT APPLICATION(S)

The present disclosure is part of a non-provisional application that claims the priority benefit of U.S. Provisional Patent Application No. 63/369,083, filed on 22 Jul. 2022, U.S. Provisional Patent Application No. 63/369,094, filed on 22 Jul. 2022, and U.S. Provisional Patent Application No. 63/478,198, filed on 3 Jan. 2023. Contents of above-listed applications are herein incorporated by reference.

### TECHNICAL FIELD

The present disclosure relates generally to video coding. In particular, the present disclosure relates to methods of coding pixel blocks by inter-prediction using affine candidates.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for refining affine candidate by regression. A video coder receives data for a block of pixels to be encoded or decoded as a current block of a current picture of a video. The video coder derives a linear model to refine a prediction candidate by regression to minimize a difference between samples of a current template neighboring the current block and samples of a reference template identified by the refined prediction candidate. The video coder generates a prediction of the current block based on the derived linear model. The video coder encodes or decodes the current block by using the generated prediction.

In some embodiments, the prediction candidate being refined is an affine motion candidate and the derived linear model is an affine motion model having four parameters for affine motion based on two check points or an affine motion model having six parameters for three check points. The affine motion candidate being refined may be a merge candidate with motion vector difference (MMVD) candidate or an adaptive motion vector prediction (AMVP) candidate. The prediction candidate being refined may also be a regular merge candidate.

In some embodiments, the refined prediction candidate is added to a list of prediction candidates for the current block. In some embodiments, the refined prediction candidate replaces the prediction candidate in a list of prediction candidates for the current block.

In some embodiments, only a subset of prediction candidates in the list of prediction candidates are refined by regression for the linear model. The subset of prediction candidates may be merge mode with motion vector difference (MMVD) candidates that are identified based on proximity to a specific direction. In some embodiments, for each MMVD candidate, only a base motion vector predictor (MVP) is refined by regression.

In some embodiments, the derived model is an affine motion model that is derived by minimizing a difference between regression subblock motion vectors and (i) subblock MVs of subblocks neighboring the current block and (ii) subblock MVs derived from an affine candidate of the current block to refine the affine candidate. The prediction is generated based on the refined affine candidate. In some embodiments, the affine motion model is derived by minimizing differences between the regression subblock motion vectors and (i) stored subblock MVs associated with subblocks neighboring the current block and (ii) inherited MVs associated with subblocks belonging to a reference affine coding unit (CU). The reference affine CU may not be adjacent to the current block.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 shows spatial and temporal candidates for merge mode.

FIG. 2 shows the control point motion vectors (CPMVs) of a current block that is coded by affine motion field.

FIG. 3 illustrates neighboring blocks that provide constructed affine candidates.

FIG. 4 shows the spatially neighboring subblocks of a current CU used for regression-based motion vector field (RMVF) motion parameter derivation.

FIGS. 5A-C conceptually illustrate using template regression to refine an affine candidate.

FIG. 6 conceptually illustrates generating an affine motion model by MV regression using neighboring subblock MVs of the current CU and inherited subblock MVs.

FIG. 7 shows bilateral matching at block level and subblock level.

FIG. 8 conceptually illustrates a refined MV being further refined by regression.

FIG. 9 illustrates an example video encoder that may refine affine candidates by regression.

FIG. 10 illustrates portions of the video encoder that implement affine candidate refinement by regression.

FIG. 11 conceptually illustrates a process that refines prediction candidates by deriving regression models.

FIG. 12 illustrates an example video decoder that may refine affine candidates.

FIG. 13 illustrates portions of the video decoder that implement affine candidate refinement by regression.

FIG. 14 conceptually illustrates a process that refines prediction candidates by deriving regression models.

FIG. 15 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Merge Mode

Skip and Merge modes obtain the motion information from spatially neighboring blocks (spatial candidates) or a temporal co-located block (temporal candidate). When a PU is Skip or Merge mode, no motion information is coded, instead, only the index of the selected candidate is coded. For Skip mode, the residual signal is forced to be zero and not coded. If a particular block is encoded as Skip or Merge, a candidate index is signaled to indicate which candidate among the candidate set is used for merging. Each merged PU reuses the MV, prediction direction, and reference picture index of the selected candidate.

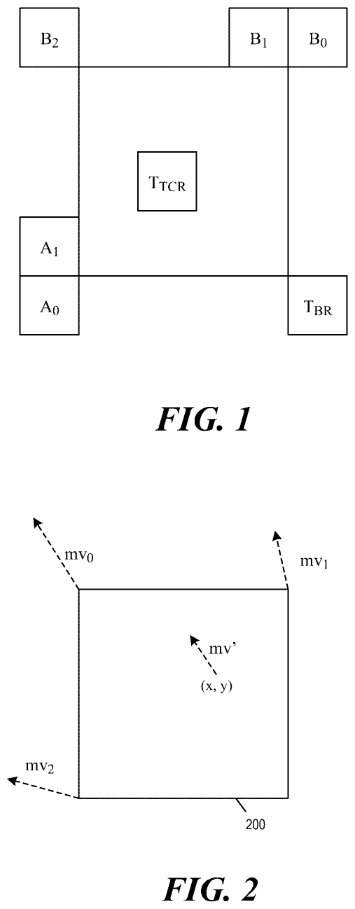

FIG. 1 shows spatial and temporal candidates for merge mode. As illustrated, up to four spatial MV candidates are derived from A₀, A₁, B₀ and B₁ spatial neighbors, and one temporal MV candidate is derived from TBR or TCTR (TBR is used first, if TBR is not available, TCTR is used instead). If any of the four spatial MV candidates is not available, the position B₂ is then used to derive MV candidate as a replacement. After the derivation process of the four spatial MV candidates and one temporal MV candidate, removing redundancy (pruning) is applied to remove redundant MV candidates. If after removing redundancy (pruning), the number of available MV candidates is smaller than five, three types of additional candidates are derived and are added to the candidate set (candidate list). The encoder selects one final candidate within the candidate set for Skip, or Merge modes based on the rate-distortion optimization (RDO) decision, and transmits the index to the decoder.

### II. Affine Motion Field

An object in a video may have different types of motion, including translation motions, zoom in/out motions, rotation motions, perspective motions and the other irregular motions. In some embodiments, a block-based affine transform motion compensation prediction is used to account for these various types of motion. VVC provides a block-based affine transform motion compensation prediction. Specifically, the affine motion field mvₓ, mv_{y} of the current block at position (x, y) is in the form of a linear model:

mvₓ=a*x+b*y+c

mv_{y}=d*x+e*y+f (0)

The coefficients {a, b, c, d, e, f} are parameters of the linear model. In some embodiments, the affine motion field at position (x, y) can be described by motion information of two control points (CPs) (at e.g., top-right and top-left corners of the block) (4-parameter model) or motion information of three control points (at e.g., top-right, top-left, and bottom-left corners of the block) (6-parameter model).

For 4-parameter affine motion model, eq.0 (motion vector at sample location (x, y) in a block) can be written as:

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix} \qquad ( 1 )$$

For 6-parameter affine motion model, eq.0 can be written as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} \qquad ( 2 )$$

Where (mv₀ₓ, mv_{0y}) is motion vector of the top-left corner control point (top-left corner CPMV, or mv₀), (mv₁ₓ, mv_{1y}) is the motion vector of the top-right corner control point (top-right corner CPMV, or mv₁), and (mv₂ₓ, mv_{2y}) is the motion vector of the bottom-left corner control point (bottom-left corner CPMV, or mv₂).

In some embodiments, a 2-parameter model can be used to refine translation inter-prediction candidate (e.g., regular merge candidates):

$${MV}_{x}^{regress} = {MV}_{x}^{orig} + biasX \qquad ( 3 )$$

$${MV}_{y}^{regress} = {MV}_{y}^{orig} + biasY$$

FIG. 2 shows the control point motion vectors (CPMVs) of a current block that is coded by affine motion field. The current block has CPMVs at top-left corner (mv₀), top-right-corner (mv₁), and bottom-left corner (mv₂). The affine motion field mv′ at positions (x, y) in the current block 200 can be derived using an affine motion model such as eq.1 (4-parameter affine model) or eq.2 (6-parameter affine model).

### III. Affine Merge Mode

Affine merge mode, or AF_MERGE mode can be applied for CUs with both width and height larger than or equal to 8. In this mode, the motion vectors at the control points (CPMVs) of the current CU are generated based on the motion information of the spatial neighboring CUs. There can be up to five CPMVP candidates, and an index is signalled to indicate the one to be used for the current CU. The following three types of CPMV candidates are used to form the affine merge candidate list: (1) inherited affine merge candidates that are extrapolated from the CPMVs of the neighbour CUs; (2) constructed affine merge candidates CPMVPs that are derived using the translational MVs of the neighbour CUs; (3) zero MVs.

An inherited affine candidate inherits an affine model from a neighboring block by directly obtaining the CPMVs from the neighboring block or utilizing the subblock MVs of the spatial candidates to derive affine model. At most two inherited affine candidates are included in the Affine merge list and the derivation process of inherited Affine candidate follows the order that the available spatial merge candidates are searched from B₀ to B₂ and A₀ to A₁.

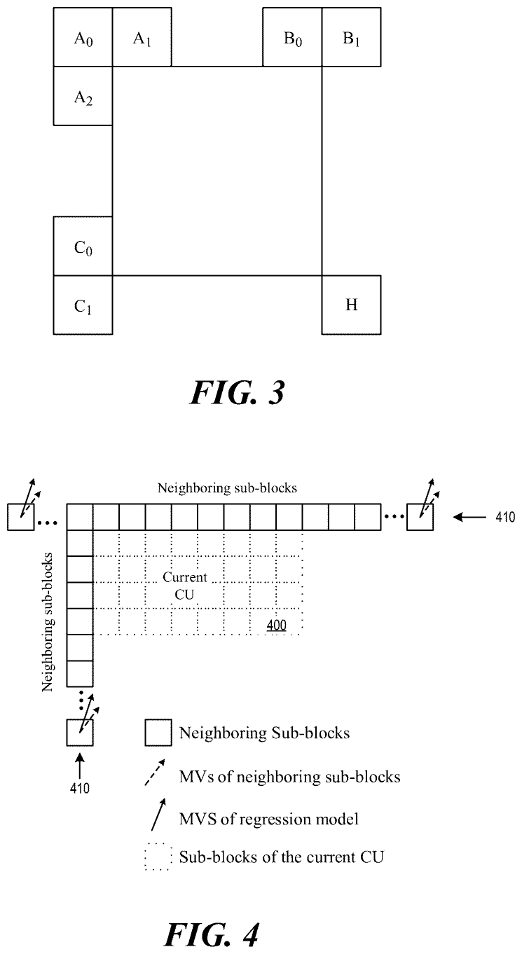

On the other hand, constructed Affine candidates are derived from the subblock MVs from different neighboring blocks. FIG. 3 illustrates neighboring blocks that provide constructed affine candidates. The constructed affine candidates are inserted into the Affine merge list by selecting two or three subblock MVs from {A, B, C, H} as input MVs to the constructed affine candidate derivation process in the following order:
A, B, C
A, B, H
A, C, H
B, C, H
A, B
A, C

At most 6 constructed Affine candidates are included in Affine merge list and the searching process of {A, B, C, H} is that taking the first available MV in {A0, A1, A2} as A, taking first available MV in {B0, B1} as B, taking the first available MV in {C0, C1} as C, and taking the subblock MVs in collocated block as H.

### IV. Regression-Based Motion Vector Field (RMVF)

Motion behavior may vary inside a block. Particularly, for larger CUs, it may not be efficient to represent the motion behavior with only one motion vector. A regression-based motion vector field (RMVF) method models such motion behavior based on the motion vectors of the spatially neighboring subblocks.

FIG. 4 shows the spatially neighboring subblocks of a current CU used for RMVF motion parameter derivation. The figure shows a current block 400 having neighboring subblocks 410. The motion vectors and center positions from the neighboring subblocks 410 of the current CU 400 are used as the input to a linear regression process to derive a set of linear model parameters {aₓₓ, a_{xy}, a_{yx}, a_{yy}, bₓ, b_{y}} for an affine motion model. The regression process minimizes the mean square error between neighboring subblock MVs and the MVs derived by a regression model. A motion vector (MV_{X_subPU}, MV_{Y_subPU}) for a subblock in the current CU 400 with the center location at (X_{subPU}, Y_{subPU}) can then be calculated as:

$$[ \begin{matrix}{MV}_{X \_ subPU} \\ {MV}_{Y\_subPU}\end{matrix} ] = [ \begin{matrix}{a}_{xx} & {a}_{xy} \\ {a}_{yx} & {a}_{yy}\end{matrix} ] [ \begin{matrix}{X}_{subPU} \\ {X}_{subPU}\end{matrix} ] + [ \begin{matrix}{b}_{x} \\ {b}_{y}\end{matrix} ] \qquad ( 4 )$$

The motion field of the current CU 400 can then be refined by the derived affine motion model having the parameters {aₓₓ, a_{xy}, a_{yx}, a_{yy}, bₓ, b_{y}}.

### IV. Affine MMVD

Unlike regular merge mode in which the implicitly derived motion information is directly used for prediction samples generation of the current CU, in Merge with Motion Vector Difference (MMVD) mode, the derived motion information is further refined by a motion vector difference MVD. MMVD also extends the list of candidates for merge mode by adding additional MMVD candidates based on predefined offsets (also referred to as MMVD offsets).

In some embodiments, MMVD is extended to Affine as Affine MMVD mode for further refining the Affine merge candidate with an MV offset. In Affine MMVD mode, the MV offsets are pre-defined and obtained from 8 directions (e.g., k×π/2 horizontal and vertical angles and k×π/4 diagonal angles) with 5 step size (i.e., {1, 2, 4, 8, 16}). An Affine MMVD candidate is generated by adding a pre-defined translational MV offset to three CPMVs and total 40 candidates are included in Affine MMVD list. After reordering Affine MMVD list with template matching cost, only 20 Affine MMVD candidates with the smallest template matching costs are kept.

V. Affine with DMVR

In order to increase the accuracy of the MVs of the merge mode, decoder side motion vector refinement (DMVR) can be applied to refine MVs by using e.g., bilateral-matching (BM). In bi-prediction operation, a refined MV is searched around the initial MVs in the reference picture list L0 and reference picture list L1. The BM method calculates the distortion between the two candidate blocks in the reference picture list L0 and list L1. The MV candidate with the lowest SAD becomes the refined MV and used to generate the bi-predicted signal.

In some embodiments, a multi-pass decoder-side motion vector refinement (MP-DMVR) method is applied in regular merge mode if the selected merge candidate meets the DMVR conditions. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The BM refines a pair of motion vectors MV0 and MV1 under the constraint that motion vector difference MVD0 (i.e., MV0′−MV0) is just the opposite sign of motion vector difference MVD1 (i.e., MV1′−MV1).

In some embodiments, MP-DMVR is used to refine affine CPMV. The 4-parameters affine mode can be described using eq. 1 above, in which only two non-translation parameters are used.

The 6-parameter affine model can be described using the eq.2 above, wherein (mvₓ, mv_{y}) is the motion vector at location (x, y). (mv₀ₓ, mv_{0y}) is the base MV representing the translation motion of the affine model, and

$$\frac{{mv}_{1 x} - {mv}_{0 x}}{W} , \frac{{mv}_{2 x} - {mv}_{0 x}}{H} , \frac{{mv}_{1 y} - {mv}_{0 y}}{W} and \frac{{mv}_{2 y} - {mv}_{0 y}}{H}$$

are four non-translation parameters which defines rotation, scaling and other non-translation motion of the affine model.

In some embodiments, the base MV of the affine model of the coding block coded is refined with the affine merge mode by only applying the first step of multi-pass DMVR. That is, a translation MV offset is added to all the CPMVs of the candidate in the affine merge list if the candidate meets the DMVR condition. And the MV offset is derived by minimizing the cost of bilateral matching, which is the same as conventional DMVR. And the DMVR condition is also not changed.

The MV offset searching process is the same as the first pass of multi-pass DMVR, in which a 3×3 square search pattern is used to loop through the search range [−8, +8] in horizontal direction and [−8, +8] in vertical direction to find the best integer MV offset. And then half pel search is conducted around the best integer position and an error surface estimation is performed at last to find a MV offset with 1/16 precision. The refined CPMV is stored for both spatial and temporal motion vector prediction as the multi-pass DMVR result.

### VI. Regression-Based Affine Candidates

### A. Affine Candidate Refinement by Template Regression

Some embodiments of the disclosure provide a method to refine affine candidates by a regression model that is generated by minimizing the mean square error (MSE) between the neighboring reconstruction samples (e.g., reconstruction samples of the first N lines at left and/or top directions, also called current template) and reference templates of the to-be-refined Affine candidates. Specifically,

$$MSE = {{\sum }_{( x , y ) ∈ B ,}}_{( {x}^{′} , {y}^{′} ) ∈ {B}^{′}} {‖ Reconstruction ( x , y ) - Template ( {x}^{′} , {y}^{′} ) ‖}^{2} or \qquad ( 5 )$$

$$MSE = {{\sum }_{( x , y ) ∈ B ,}}_{( {x}^{′} , {y}^{′} ) ∈ {B}^{′}} {‖ CurTemplate ( x , y ) - RefTemplate ( {x}^{′} , {y}^{′} ) ‖}^{2}$$

where (x, y) indicates the position relative to the top-left position of the reconstruction block and (x′, y′) indicates the position relative to the top-left position of the reference template block. B indicates the current template region, and B′ indicates the reference template region. The reference template block is located by a regression MV that is generated by the regression model. The regression model can be 4-parameter (eq.1) or 6-parameter affine type model (eq.2) or even 2-parameter translational type model (eq.3).

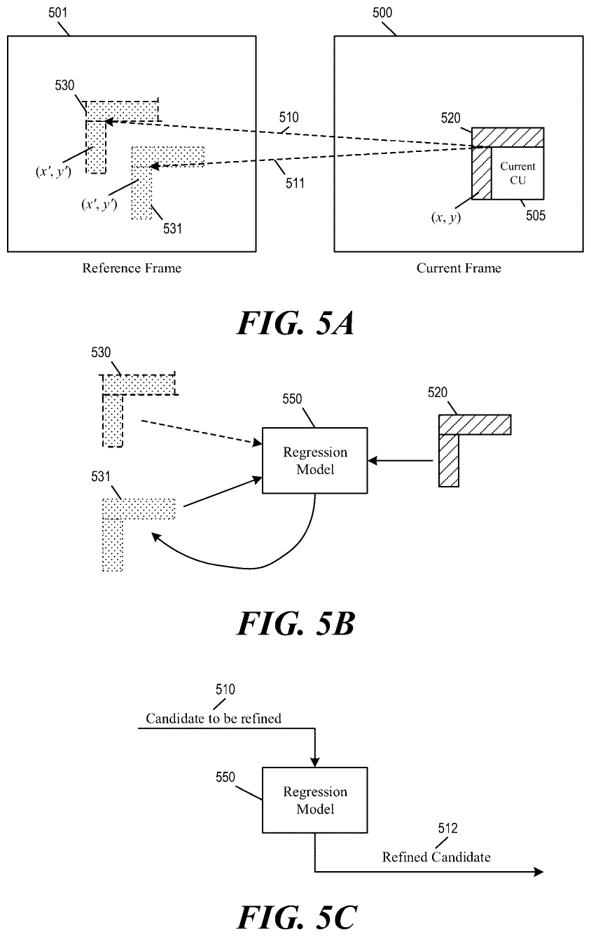

FIGS. 5A-C conceptually illustrate using template regression to refine an affine candidate. As illustrated in FIG. 5A, a current CU 505 in a current picture 500 has an affine candidate 510. The affine candidate 510 is used to locate a corresponding reference template region 530 in a reference picture 501. A neighboring region 520 of the current CU 510 is used as a current template.

FIG. 5B shows the samples of the current template 520 and samples of the reference template 530 being used to generate a linear model 550 by regression (so the linear model 550 is also a regression model). The regression is used to solve the parameters of the linear model. The linear model 550 being solved may be a 4-parameter or 6-parameter affine motion model, in form of eq.1 or eq.2. The regression is driven by minimization of the MSE between the samples of the current template 520 and of the reference template 530 according to eq.5.

FIG. 5A and FIG. 5B also show the regression process. The linear motion model 550 under regression is used to generate a regression MV 511 that locates an updated reference template region 531, the samples of which are used to update the MSE calculation in place of the samples of the initial reference template region 530. The regression MV 511 may be continuously updated until the calculated MSE according to eq.5 is minimized.

FIG. 5C shows that the completed affine motion model 550 being applied to the affine candidate 510 to generate a refined affine candidate 512, which may be the final regression MV 511.

In some embodiments, one or more than one affine merge candidates in an affine merge candidate list are refined by a regression model that is derived by minimizing the mean square error between the neighboring reconstruction samples (e.g., current template 520, which includes reconstruction samples of the first N lines at left and/or top directions) and the reference templates (e.g., reference template 531) of the to-be-refined affine merge candidates.

In some embodiments, one or more than one merge candidates in a merge candidate list are refined by a 2-parameter translational regression model which minimizes the mean square error between the neighboring reconstruction samples and the reference templates of the to-be-refined merge candidates. The merge candidates can also be refined in the similar way as Bi-directional Optical Flow (BDOF).

In some embodiments, one or more MMVD candidates in an MMVD candidate list are refined by 2-parameter translational regression model which minimizes the mean square error between the neighboring reconstruction samples and the reference templates of the to-be-refined MMVD candidates. The MMVD candidates can also be refined in the similar way as Bi-directional Optical Flow (BDOF).

In some embodiment, one or more Affine MMVD candidates in an affine MMVD candidate list are refined by a regression model that minimizes mean square error between the neighboring reconstruction samples and the reference templates of the to-be-refined Affine MMVD candidates. After the refinement, the affine MMVD candidates are then reordered by template matching cost and only N candidates with minimum template matching cost are kept.

In some embodiments, the affine MMVD candidates are first reordered by template matching cost and only N candidates with minimum template matching cost are kept while the other candidates are discarded. The remaining N Affine MMVD candidates are then refined by a regression model that minimizes mean square error between the neighboring reconstruction samples and the reference templates of the to-be-refined Affine MMVD candidates.

In some embodiments, the base affine MMVD candidate is refined by a regression model. The model is used to determine which MMVD candidate is preferred. The MMVD candidates are reordered according to the regression model refined affine candidate.

In some embodiments, one or more affine AMVP candidates in an affine AMVP candidate list are refined by regression models that minimize mean square errors between the neighboring reconstruction samples and the reference templates of the to-be-refined affine AMVP candidates. After the refinement, the Affine AMVP candidates of the affine AMVP candidate list can then be reordered by template matching cost and only N candidates with minimum template matching cost are kept.

In some embodiments, the affine AMVP candidates are first reordered by template matching cost and only N candidates with minimum template matching cost are kept. The kept N Affine AMVP candidates are then refined by regression models which minimize mean square error between the neighboring reconstruction samples and the reference templates of the to-be-refined affine AMVP candidates.

In some embodiments, the regression model (e.g., using sample regression or MV regression) can be used as a decoder-side MV refinement process (DMVR). For example, when an affine candidate satisfies some constraints, the affine candidate is refined by the regression model. Examples of such constraints include CU size constraint (e.g., CU size/width/height is >, >=, <, or <=some threshold), neighboring MV/subblock-MV number constraint, neighboring reconstruction sample number constraint, inter prediction direction constraint, true-bi-prediction constraint, etc.

### B. Generating Affine Candidate by Template Regression

Some embodiments of the disclosure provide a regression-based affine candidate that is derived by minimizing the mean square error between the current template samples (i.e., neighboring reconstruction samples of the current block) and the reference template samples of a to-be-refined affine candidate. For example, in the example of FIG. 5, the refined affine candidate 511 may be considered a regression-based affine candidate that can be added to the affine candidate list.

In some embodiments, a total of K regression-based affine candidates may be included into the affine candidate list if K affine candidates and adjacent or non-adjacent affine CUs are available. One or more than one of the K regression-based Affine candidates may replace any candidates in the affine candidate list, or be added additionally into the affine candidate list. The same method can be applied to derive other types of regression-based affine candidate, such as a regression-based affine merge candidate in an affine merge candidates list, or a regression-based affine AMVP candidate in an affine AMVP candidates list, or a regression-based MMVD AMVP candidate in an affine MMVD candidates list.

In some embodiments, the regression-model-refined affine candidates can be used to replace the affine candidate in the candidate list (e.g., affine merge candidate list, affine MMVD candidate list, or affine AMVP candidate list), or can be inserted into the candidate list. For example, the regression-model-refined affine candidates can be added after the original candidates, or after first N candidates, or after certain type of candidates in the candidates list. The number of added regression-model-refined affine candidates can also be constrained.

### C. Generating Merge Candidate by Template Regression

In some embodiments, a regression-based merge candidate is derived by using the reference template of a merge candidate or the reference template of a non-adjacent merge CU as input to derive a 2-parameter translational regression model that minimizes the mean square error between the neighboring reconstruction samples (current template) and the reference templates of the to-be-refined merge candidates. Total K regression-based merge candidates maybe included into merge candidate list if K merge candidates and non-adjacent merge CUs are available. One or more of the K regression-based merge candidates may replace any candidates in the merge candidate list or be added additionally into the merge candidate list. The merge candidates can also be refined in the similar way as Bi-directional Optical Flow (BDOF).

### D. Refine Affine Candidate by MV Regression

In some embodiments, the Regression Motion Vector Field (RMVF) method described in Section IV above can be applied to refine one or more affine candidates in an affine candidate list by corresponding regression models. Each regression model takes as input (i) neighboring subblock MVs and (ii) subblock MVs of the current block (e.g., current CU) derived from an affine candidate. The regression model is based on regression to minimize the mean square error between the neighboring subblock MVs and the subblock MVs derived by the regression model. The regression model can be a 4-parameter or 6-parameter affine type model or 2-parameter translational type model. This is referred to as motion vector (MV) regression, in contrast to template (TM) regression described above.

In some embodiments, the affine refinement model is a linear regression model derived by minimizing mean square error (MSE) between (i) inherited and/or neighbor subblock MVs and (ii) MVs derived by the regression model. The inherited subblock MVs are taken from subblock motion field from a previously coded affine block as a reference affine CU, which maybe a non-adjacent affine CU or a history-based affine CU. The neighbor subblock MVs are taken from 4×4 subblocks neighboring the current CU.

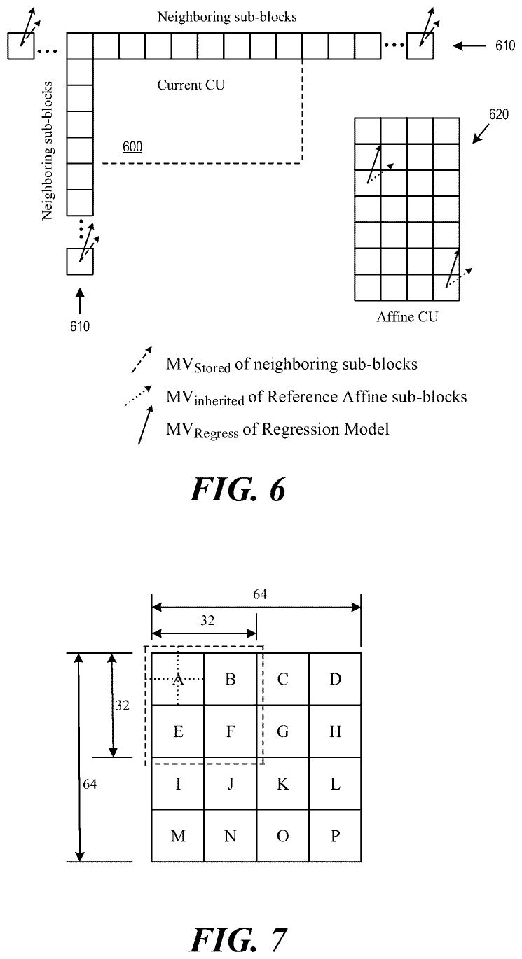

FIG. 6 conceptually illustrates generating an affine motion model by MV regression using neighboring subblock MVs of the current CU and inherited subblock MVs. The figure shows, for coding a current block 600, (i) stored MVs (MV_{stored}) associated with neighboring subblocks 610 neighboring the current block 600, and (ii) inherited MVs (MV_{inherited}) associated with subblocks belonging to a previously coded affine block 620 as a reference affine CU. The reference affine CU 620 may be an affine CU that is non-adjacent to the current block, or a history-based affine CU. The figure also shows (iii) regression MVs (MV_{regress}) generated by the regression model during regression. The linear regression model to be solved is as followed.

$$MSE = {\sum }_{( x , y ) ∈ {B}_{1}} {‖ {MV}_{x , y}^{inherited} - {MV}_{x , y}^{regress} ‖}^{2} + {\sum }_{( x , y ) ∈ {B}_{2}} {‖ {MV}_{x , y}^{stored} - {MV}_{x , y}^{regress} ‖}^{2} \qquad ( 6 )$$

where B₁ indicate the region of reference affine-coded CU (e.g., non-adjacent or historical affine CU 620) and B₂ indicates the neighboring region of the current CU (e.g., neighboring subblocks 610). The linear model is constructed by finding the MV_{x,y}^{regress} for all subblock positions x,y of B₁ and B₂ that minimizes the mean-square error (MSE). The regression models can be 4-parameter (Eq. 1) or 6-parameter affine type model (Eq. 2) or even 2-parameter translational type model.

### E. Refine Affine MMVD Candidate by MV Regression

In some embodiments, a base affine MMVD candidate is refined by regression model. The refined base affine MMVD candidate is used to determine which MMVD candidate is preferred. The MMVD candidates are reordered according to the regression-model-refined affine candidate.

In some embodiments, the regression-model-refined affine candidates can be used to replace the affine candidate in the candidate list (e.g., merge candidate list, MMVD candidate list, or AMVP candidate list), or can be inserted into the candidate list. In some embodiments, the regression-model-refined affine candidates can be added to the candidate list after the original candidates, or after first N candidates, or after certain type of candidates. The number of added regression model refined affine candidates can also be constrained.

In some embodiments, based on the RMVF method, the neighboring subblock MVs of the current CU are taken as input to derive a regression model (denoted as Mn). Furthermore, the motion field in the current CU derived from each Affine MMVD candidate is used to derive a set of regression models (denoted as {Ma1, Ma2, . . . , MaN}, where N=the number of Affine MMVD candidate). By blending Mn with {Ma1, Ma2, . . . , MaN} in a certain derivation method (e.g., linear and/or non-linear combination of two affine models according to the step size and/or the direction), a final set of regression models can be obtained ({Mf1, Mf2, . . . , MfN}, where N=the number of Affine MMVD candidate). The final set of regression models are used to refine the motion field of each Affine MMVD candidate.

The set of regression models {Mf1, Mf2, . . . , MfN} can also be used to derive N CPMV candidates for the Affine MMVD candidates. In this method, the regression of the neighboring subblock MVs only needs to be performed once.

The blending process can be applied at subblock MV level, affine parameter level, or CPMV level. The blending process may be conditioned by the number of spatially neighboring subblock MVs, the number of subblock MVs in the reference block of each Affine MMVD candidate, the number of subblock of the current block, the MV amplitude of each Affine MMVD candidate, the step size and direction of Affine MMVD, CU size/width/height, and any of the combination of above. The blending at the level of the affine parameters may use the information of the number of spatially neighboring subblock MVs, the number of subblock MVs in the reference block of each affine

MMVD candidate, the number of subblock of the current block, the MV amplitude of each Affine MMVD candidate, the step size and direction of Affine MMVD, and any of the combination of above.

### F. Blending Template Regression Model and MV Regression Model

In some embodiments, a first regression model by template regression (described in Section A above) and a second regression model by MV regression (described in Section D above) are blended to derive a fusion regression model. Specifically, the reference templates of an affine merge or affine AMVP candidate or the reference templates of a non-adjacent affine CU can be used to derive the first regression model (referred to as Ma), by minimizing the mean square error between the neighboring reconstruction samples and the reference templates of the to-be-refined Affine candidates using template regression. The neighboring and inherited subblock MVs from the corresponding affine merge or affine AMVP candidate or the corresponding non-adjacent affine CU are taken as input to derive the second regression model (referred to as Mb) by minimizes the mean square error between neighboring and inherited subblock MVs using MV regression.

By blending Ma and Mb in a certain derivation method (e.g., linear and/or non-linear combination of two affine models according to pre-defined weights), a blended or fusion regression model (referred to as Mf) is derived. Total K regression-based Affine candidates derived from Mf are incorporated into Affine merge or Affine AMVP candidate list if K Affine merge or Affine AMVP candidates and non-adjacent affine CUs are available. One or more than one of the K regression-based Affine candidates may replace any candidates in the Affine merge or Affine AMVP candidate list or be added additionally into the Affine merge or Affine AMVP candidate list.

In some embodiments, affine MMVD candidates are refined by the blended regression model (Mf) that is a combination of the regression model minimizing the MV errors and the regression model minimizing the template sample errors. The blended regression model is used for the refinement of one or more affine MMVD candidates.

In some embodiments, based on the RMVF method, the neighboring subblock MVs of current CU are taken as input to derive a regression model (denoted as Mn), and the motion fields in the current CU derived from a set of affine MMVD candidate are used to derive a set of regression models (denoted as {Ma1, Ma2, . . . , MaN}, where N=the number of Affine MMVD candidate). In addition, the reference templates of each affine MMVD candidate are used to derive another set of regression models (denoted as {Mb1, Mb2, . . . , MbN}, where N=the number of Affine MMVD candidate) which minimizes the mean square error between the neighboring reconstruction samples and the reference templates of each affine MMVD candidate (template regression). By blending Mn with {Ma1, Ma2, . . . , MaN} and {Mb1, Mb2, . . . , MbN} in a certain derivation method (e.g., linear and/or non-linear combination of three affine models according to the step size and/or the direction), a final set of regression models can be obtained ({Mf1, Mf2, . . . , MIN}, where N=the number of affine MMVD candidate). The final set of regression models are used to refine the motion field of each Affine MMVD candidate. The set of regression models {Mf1, Mf2, . . . , MfN} can be used to derive N CPMV candidates for the Affine MMVD candidates. In some embodiments, the regression of the neighboring subblock MVs is performed only once.

The blending process may be applied at subblock MV level, affine parameter level, or CPMV level. The blending process can be conditioned by the number of current template samples, number of reference template samples, number of spatially neighboring subblock MVs, the number of subblock MVs in the reference block of each affine MMVD candidate, the number of subblock of the current block, the MV amplitude of each Affine MMVD candidate, the step size and direction of Affine MMVD, CU size/width/height, QP value, and any of the combination of above. The blending at the affine parameter level may use the information of the number of spatially neighboring subblock MVs, the number of subblock MVs in the reference block of each Affine MMVD candidate, the number of subblock of the current block, the MV amplitude of each affine MMVD candidate, the step size and direction of affine MMVD, and any of the combination of above.

### G. Reduce Affine MMVD Merge Candidate by Regression

In some embodiments, the base MVP of affine MMVD mode is refined with regression. The method further determines the step size and/or direction of affine MMVD according to the CPMV difference between the original and refined affine MMVD base MVP. The closest Affine MMVD direction with the angle of the CPMV difference is denoted as Dc and the closest Affine MMVD step size with the amplitude of the CPMV difference is denoted as Sc. In some embodiments, only K (indicates a pre-defined number) affine MMVD candidates near the direction Dc and the step size Sc are reordered by template matching cost to reduce the computations of template matching cost calculation or reduce the signaling overhead for affine MMVD direction and/or step size. The regression model can minimize the mean square error between the neighboring and inherited (from Affine MMVD base MVP) subblock MVs and the MVs derived by regression model and/or minimize mean square error between the neighboring reconstruction samples and the reference template samples of the Affine MMVD base MVP.

In some embodiments, the remaining candidates after the reduction are further refined by regression. Specifically, only K (indicated a pre-defined number) affine MMVD candidates near the direction Dc and the step size Sc are refined by regression models to reduce the computations of regression matrices solving. The K affine MMVD candidates are then reordered by template matching cost, and N candidates with minimum template matching cost are kept. The regression model is derived by minimizing the mean square error between the neighboring and inherited subblock MVs (i.e., the subblock MVs derived from Affine MMVD base MVP or Affine MMVD candidates) and the MVs derived by regression model and/or minimize mean square error between the neighboring reconstruction samples and the reference templates of the affine MMVD base MVP or affine MMVD candidates.

### H. Reduce MMVD Merge Candidate by Regression Result

In some embodiments, (only) the base MVP of MMVD mode is refined by regression. The method further determines the step sizes and/or directions of MMVD according to the MVP difference between the original and refined MMVD base MVPs. The closest MMVD direction with the angle of the MVP difference is denoted as Dc and the closest MMVD step size with the amplitude of the MV difference is denoted as Sc. Only K (a pre-defined number) MMVD candidates near the direction Dc and the step size Sc are added into MMVD candidate list to save the signaling overhead for MMVD direction and/or step size. The regression model may minimize the mean square error between the neighboring and inherited (from MMVD base MVPs) subblock MVs and the MVs derived by regression model and/or the mean square error between the neighboring reconstruction samples and the reference templates of the MMVD base MVPs.

In some embodiments, only K (indicated a pre-defined number) inter MMVD candidates near the direction Dt and the step size St are reordered by template matching cost to reduce the computations of template matching cost calculation or reduce the signaling overhead for inter MMVD direction and/or step size.

### J. Refine Affine Motion by Bilateral Matching

In some embodiments, one to-be-tested motion offset is added to all CPMVs to be to-be-tested CPMVs. Next, the subblock MVs are derived accordingly and followed by calculating the difference between two predictors in the pass 1 of bilateral matching algorithm. The to-be-tested CPMVs with the minimum difference is selected as the refined CPMVs. In some embodiments, all CPMVs of an affine coded block can be refined with the same motion offset derived by bilateral matching algorithm with pass 1, pass 2 and/or pass 3.

In some embodiments, all subblock motions of an affine coded block are derived based on CPMVs first. After that, all subblock motions are added with the same motion offset which is to be tested in bilateral matching algorithm. The differences between two predictors are calculated and used to select the best motion offset among these to-be-tested motion offsets. In this method, the derivation process of affine subblock motions can be applied only one time when testing different to-be-tested motion offsets.

### K. Refine Affine Motions by Bilateral Matching at Block Level and Subblock Level

In some embodiments, after deriving all subblock motions based on CPMVs, subblock motions in a pre-defined region are refined by bilateral matching. A motion offset is then derived based on the bilateral matching, and the derived motion offset is added to all subblock motions in the pre-defined region. For example, if a pre-defined region is 16×16, a 32×32 affine coded block will be partitioned into four regions and four motion offsets for the subblocks in the corresponding region are derived.

FIG. 7 shows bilateral matching at block level and subblock level. In the figure, A, B, C, D . . . P are 8×8 subblocks in one affine coded CU. After deriving all subblock motions based on CPMVs, motions in each 16×16 region (A, B, E, F) (C, D, G, H) (I, J, M, N) (K, L, O, P) are used to derive one motion offset. Subblocks A, B, E, and F are used to derive one motion offset, and the derived motion offset is used to refine the subblock motion in A, B, E, and F. Subblocks C, D, G, and H are used to derive one motion offset, and the derived motion offset is used to refine the subblock motion in C, D, G, and H. Subblocks I, J, M, and N are used to derive one motion offset, and the derived motion offset is used to refine the subblock motion in I, J, M, and N. Subblock K, L, O, and P are used to derive one motion offset, and the derived motion offset is used to refine the subblock motion in K, L, O, and P.

In some embodiments, the derived motion offsets in the above are added back to the corresponding CPMVs to derive the refined CPMVs. The final subblock motions are derived according to the refined CPMVs. In some embodiments, the refined subblock motions in the above are used to derive the refined CPMVs by using some regression method. The final subblock motions are derived according to the refined CPMVs.

In some embodiments, hierarchical bilateral matching motion refinement is used. For example, two pre-defined regions are 32×32, and 8×8. For an affine coded CU, after deriving all subblock motions based on CPMVs, all subblock motions in one 32×32 region will be refined by the same motion offset derived by bilateral matching. After that, for each subblock motion in one 16×16 region is refined again by the same motion offset derived by bilateral matching.

For example, a 64×64 affine coded block includes four 32×32 regions (A, B, E, F) (C, D, G, H) (I, J, M, N) (K, L, O, P). Based on all subblock motions in region (A, B, E, F), one motion offset is be derived and added to all subblock motions in region (A, B, E, F). Based on all subblock motions in region (C, D, G, H), one motion offset is derived and added to all subblock motions in region (C, D, G, H). Based on all subblock motions in region (I, J, M, N), one motion offset is derived and added to all subblock motions in region (I, J, M, N). Based on all subblock motions in region (K, L, O, P), one motion offset is derived and added to all subblock motions in region (K, L, O, P). After that, four 8×8 subblocks in region A (16×16) are used to derive one motion offset that is added to the four subblock motions in region A. Similar to each 16×16 region (A, B, C, D, . . . . P) in the 64×64 affine coded block. The pre-defined region size in above mentioned embodiment can be designed based on CU size, or picture size.

In some embodiments, hierarchical bilateral matching motion refinement is used. Only if the bilateral matching cost of a shallow depth motion refinement is larger than a threshold, bilateral matching in the deeper depth will be applied. The threshold can be designed based on CU size. For example, the bilateral matching cost of each 32×32 region is calculated after adding the corresponding motion offset. In a 32×32 region, only if the calculated bilateral matching cost is larger than half of CU size, bilateral matching with subblocks in 16×16 regions will be performed.

In some embodiments, the derived motion offsets in the above are added back to the corresponding CPMVs to derive the refined CPMVs. The final subblock motions are derived according to the refined CPMVs. In another embodiment, the refined subblock motions in the above are used to derive the refined CPMVs by using some regression method. The final subblock motions are derived according to the refined CPMVs.

In some embodiments, the bilateral matching can be replaced by template matching in the above description. When templated matching is used instead of bilateral matching, only the subblocks located at CU top and left boundaries are used to determine the derived motion offsets. For other subblocks not located at CU top and left boundaries, the derived motion offsets can be the same as the derived one or set to zero.

L. Refine sbTMVP Motions by Bilateral Matching

In some embodiment, after deriving all subblock motions of a subblock-based Temporal Motion Vector Prediction (sbTMVP) coded block, a motion refinement will be derived by bilateral matching. After that, the derived motion refinement will be added to all subblock motions. By doing this, all reference subblocks of a sbTMVP coded block can be shifted together based on the results of bilateral matching. The previously mentioned bilateral matching method can be MP-DMVR with Pass 1, Pass 2, and/or Pass 3.

In some embodiments, after deriving all subblock motions of a sbTMVP coded block, all subblocks in a pre-defined region will be grouped to derive one motion offset. And the derived motion offset will be used to refine all subblock motions in the pre-defined region. For example, the region can be 16×16 or 32×32. For another example, the region shall include half or quarter of subblocks within the sbTMVP coded block. For another example, the region can be designed based on CU size or picture size.

In some embodiments, after deriving all subblock motions of a sbTMVP coded block, a hierarchical motion refinement is used. For example, subblocks in every 32×32 of a sbTMVP coded block are used to derive one motion offset. If current sbTMVP coded block is 64×64, 4 motion offsets will be derived based on the subblocks in 4 32×32 regions respectively. After that, in one 32×32 region, 4 motion offsets will be derived based on the subblocks in every 16×16 respectively, and the derived motion offset will be added to the corresponding subblock motions.

In some embodiments, after deriving all subblock motions of a sbTMVP coded block, a hierarchical motion refinement is used. Only if the bilateral matching cost of a shallow depth motion refinement is larger than a threshold, bilateral matching in the deeper depth will be applied. The threshold can be designed based on CU size. For example, the bilateral matching cost of each 32×32 is calculated after adding the corresponding motion offset. In a 32×32 region, only if the calculated bilateral matching cost is larger than half of CU size, bilateral matching with subblocks in 16×16 regions will be performed.

In some embodiments, the bilateral matching can be replaced by template matching in the above description. When template matching is used instead of bilateral matching, only the subblocks located at CU top and left boundaries are used to determine the motion offset. For other subblocks not located at CU top and left boundaries, the motion offset can be the same as the derived one or set to zero.

Any of the proposed invention and concept can be combined. The regression model mentioned in inventions and embodiments related to Affine inter prediction mode can be 4-parameter or 6-parameter affine type model or even 2-parameter translational type model. The regression model mentioned in the disclosure related to inter prediction mode can be 2-parameter translational type model or can be replaced by any refinement method in the similar way as BDOF.

M. Combining Affine MP-DMVR with Regression

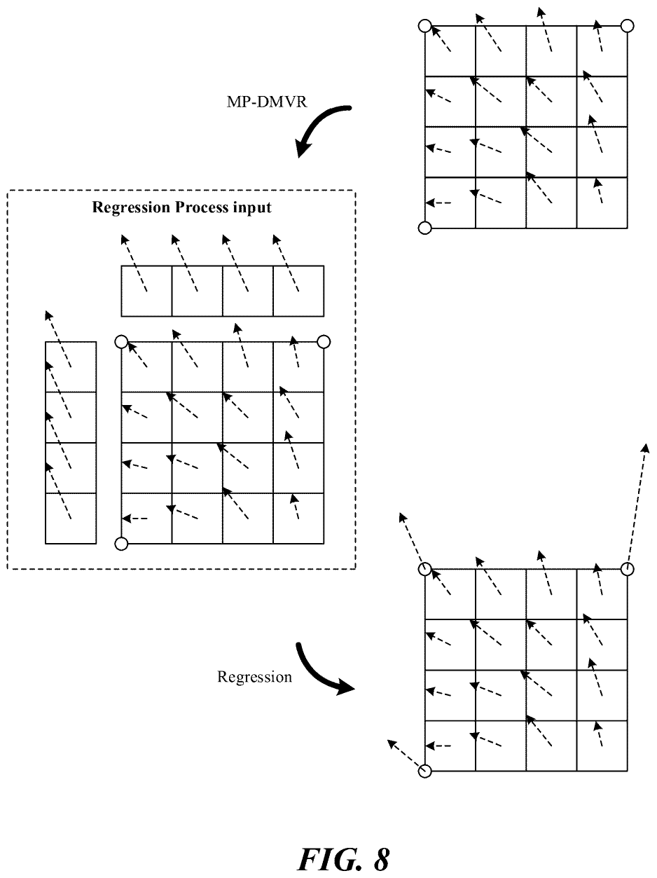

In some embodiments, the MVs refined by MP-DMVR related motion refinement method can be further refined by regression-based motion refinement. FIG. 8 conceptually illustrates an MP-DMVR refined MV being further refined by regression. The figure illustrates 3 CPMVs being derived by a regression process which takes the MP-DMVR refined sub-block MVs in the current CU as input.

The 3 CPMVs are first refined by template matching or bilateral matching respectively. A regression process takes sub-block MVs in the current CU as input to derive a regression model. The sub-block MVs are derived from refined CPMVs and the neighboring sub-blocks. The regression-based CPMVs can be compared with MP-DMVR refined CPMVs by bilateral or template matching cost to obtain the best CPMVs of current CU with minimum cost.

Any of the foregoing proposed methods can be implemented in encoders and/or decoders. For example, any of the proposed methods can be implemented in an affine inter prediction module and/or translational inter prediction module of an encoder and/or a decoder. Alternatively, any of the proposed methods can be implemented as a circuit coupled to affine inter prediction module and/or translational inter prediction module of the encoder and/or the decoder.

### VII. Example Video Encoder

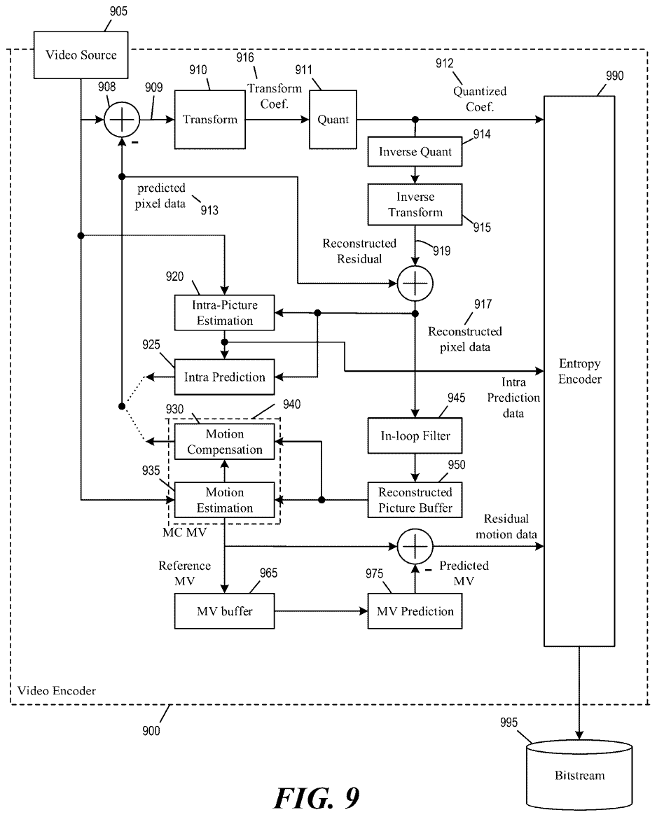

FIG. 9 illustrates an example video encoder 900 that may refine affine candidates by regression. As illustrated, the video encoder 900 receives input video signal from a video source 905 and encodes the signal into bitstream 995. The video encoder 900 has several components or modules for encoding the signal from the video source 905, at least including some components selected from a transform module 910, a quantization module 911, an inverse quantization module 914, an inverse transform module 915, an intra-picture estimation module 920, an intra-prediction module 925, a motion compensation module 930, a motion estimation module 935, an in-loop filter 945, a reconstructed picture buffer 950, a MV buffer 965, and a MV prediction module 975, and an entropy encoder 990. The motion compensation module 930 and the motion estimation module 935 are part of an inter-prediction module 940.

In some embodiments, the modules 910-990 are modules of software instructions being executed by one or more processing units (e.g., a processor) of a computing device or electronic apparatus. In some embodiments, the modules 910-990 are modules of hardware circuits implemented by one or more integrated circuits (ICs) of an electronic apparatus. Though the modules 910-990 are illustrated as being separate modules, some of the modules can be combined into a single module.

The video source 905 provides a raw video signal that presents pixel data of each video frame without compression. A subtractor 908 computes the difference between the raw video pixel data of the video source 905 and the predicted pixel data 913 from the motion compensation module 930 or intra-prediction module 925 as prediction residual 909. The transform module 910 converts the difference (or the residual pixel data or residual signal 908) into transform coefficients (e.g., by performing Discrete Cosine Transform, or DCT). The quantization module 911 quantizes the transform coefficients into quantized data (or quantized coefficients) 912, which is encoded into the bitstream 995 by the entropy encoder 990.

The inverse quantization module 914 de-quantizes the quantized data (or quantized coefficients) 912 to obtain transform coefficients, and the inverse transform module 915 performs inverse transform on the transform coefficients to produce reconstructed residual 919. The reconstructed residual 919 is added with the predicted pixel data 913 to produce reconstructed pixel data 917. In some embodiments, the reconstructed pixel data 917 is temporarily stored in a line buffer (not illustrated) for intra-picture prediction and spatial MV prediction. The reconstructed pixels are filtered by the in-loop filter 945 and stored in the reconstructed picture buffer 950. In some embodiments, the reconstructed picture buffer 950 is a storage external to the video encoder 900. In some embodiments, the reconstructed picture buffer 950 is a storage internal to the video encoder 900.

The intra-picture estimation module 920 performs intra-prediction based on the reconstructed pixel data 917 to produce intra prediction data. The intra-prediction data is provided to the entropy encoder 990 to be encoded into bitstream 995. The intra-prediction data is also used by the intra-prediction module 925 to produce the predicted pixel data 913.

The motion estimation module 935 performs inter-prediction by producing MVs to reference pixel data of previously decoded frames stored in the reconstructed picture buffer 950. These MVs are provided to the motion compensation module 930 to produce predicted pixel data.

Instead of encoding the complete actual MVs in the bitstream, the video encoder 900 uses MV prediction to generate predicted MVs, and the difference between the MVs used for motion compensation and the predicted MVs is encoded as residual motion data and stored in the bitstream 995.

The MV prediction module 975 generates the predicted MVs based on reference MVs that were generated for encoding previously video frames, i.e., the motion compensation MVs that were used to perform motion compensation. The MV prediction module 975 retrieves reference MVs from previous video frames from the MV buffer 965. The video encoder 900 stores the MVs generated for the current video frame in the MV buffer 965 as reference MVs for generating predicted MVs.

The MV prediction module 975 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 995 by the entropy encoder 990.

The entropy encoder 990 encodes various parameters and data into the bitstream 995 by using entropy-coding techniques such as context-adaptive binary arithmetic coding (CABAC) or Huffman encoding. The entropy encoder 990 encodes various header elements, flags, along with the quantized transform coefficients 912, and the residual motion data as syntax elements into the bitstream 995. The bitstream 995 is in turn stored in a storage device or transmitted to a decoder over a communications medium such as a network.

The in-loop filter 945 performs filtering or smoothing operations on the reconstructed pixel data 917 to reduce the artifacts of coding, particularly at boundaries of pixel blocks. In some embodiments, the filtering or smoothing operations performed by the in-loop filter 945 include deblock filter (DBF), sample adaptive offset (SAO), and/or adaptive loop filter (ALF).

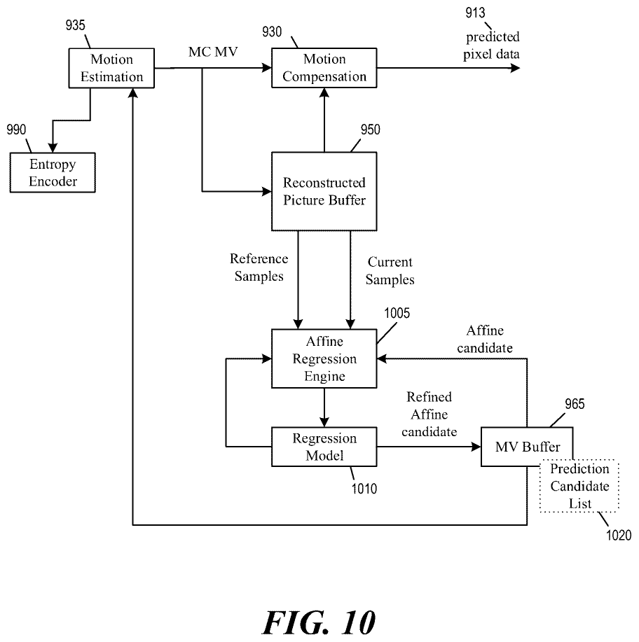

FIG. 10 illustrates portions of the video encoder 900 that implement affine candidate refinement by regression. As illustrated, the motion estimation module 935 searches the content of the reconstructed picture buffer 950 to determine a MV for motion compensation. Specifically, the motion estimation module 935 may select a prediction candidate from a prediction candidate list 1020 based on the result of the search, and provides the selected prediction candidate to the motion compensation module 930 to generate the predicted pixel data for inter-prediction 913. The selection may also be provided to the entropy encoder 990 to be signaled in the bitstream.

The prediction candidates list 1020 may include merge candidates and affine candidate(s). The affine candidates may be affine MMVD candidates and/or affine AMVP candidates and/or affine merge candidates. The prediction candidates are stored in the MV buffer 965. Some of the affine candidates in the list may be refined or generated by a regression model 1010.

A regression engine 1005 performs regression to generate the regression model 1010 based on content of the reconstructed picture buffer 950 and the MV buffer 965. The regression model 1010 may be generated by template regression that minimizes a difference between samples of a current template neighboring the current block and samples of a reference template identified by the refined prediction candidate. The regression model 1010 may also be generated by MV regression that minimizes differences between (i) subblock MVs of subblocks neighboring the current block and (ii) subblock MVs derived from an affine candidate of the current block. The regression model may also be a blended model of a first model created by template regression and a second model created by MV regression. In some embodiments, only a subset of the prediction candidates in the list are subject to refinement by regression model.

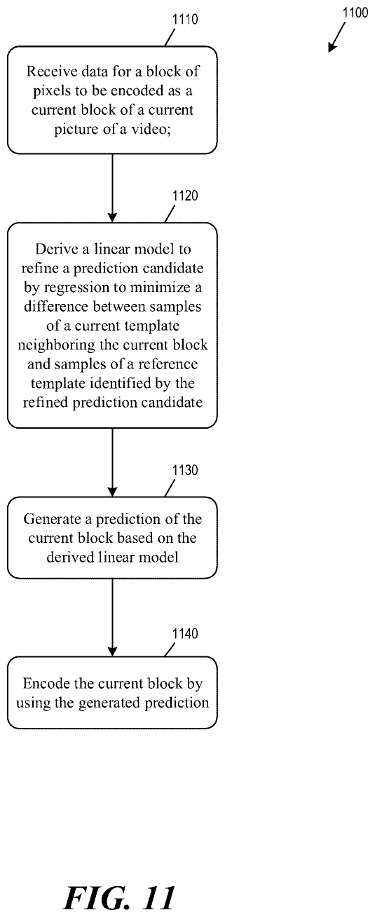

FIG. 11 conceptually illustrates a process 1100 that refines prediction candidates by deriving regression models. In some embodiments, one or more processing units (e.g., a processor) of a computing device implementing the encoder 900 performs the process 1100 by executing instructions stored in a computer readable medium. In some embodiments, an electronic apparatus implementing the encoder 900 performs the process 1100.

The encoder receives (at block 1110) data to be encoded as a current block of pixels in a current picture of a video. The encoder derives (at block 1120) a linear model to refine a prediction candidate by regression to minimize a difference between samples of a current template neighboring the current block and samples of a reference template identified by the refined prediction candidate.

In some embodiments, the prediction candidate being refined is an affine motion candidate and the derived linear model is an affine motion model having four parameters for affine motion based on two check points or an affine motion model having six parameters for three check points. The affine motion candidate being refined may be a merge candidate with motion vector difference (MMVD) candidate or an adaptive motion vector prediction (AMVP) candidate. The prediction candidate being refined may also be a regular merge candidate.

In some embodiments, the refined prediction candidate is added to a list of prediction candidates for the current block. In some embodiments, the refined prediction candidate replaces the prediction candidate in a list of prediction candidates for the current block.

In some embodiments, only a subset of prediction candidates in the list of prediction candidates are refined by regression for the linear model. The subset of prediction candidates may be merge mode with motion vector difference (MMVD) candidates that are identified based on proximity to a specific direction. In some embodiments, for each MMVD candidate, only a base motion vector predictor (MVP) is refined by regression.

The encoder generates (at block 1130) a prediction of the current block based on the derived linear model. The prediction may be generated based on the refined prediction candidate. The encoder encodes (at block 1140) the current block by using the generated prediction to produce prediction residuals.

In some embodiments, the derived model is an affine motion model that is derived by minimizing a difference between regression subblock motion vectors and (i) subblock MVs of subblocks neighboring the current block and (ii) subblock MVs derived from an affine candidate of the current block to refine the affine candidate. The prediction is generated based on the refined affine candidate. In some embodiments, the affine motion model is derived by minimizing differences between the regression subblock motion vectors and (i) stored subblock MVs associated with subblocks neighboring the current block and (ii) inherited MVs associated with subblocks belonging to a reference affine coding unit (CU). The reference affine CU may not be adjacent to the current block.

### VIII. Example Video Decoder

In some embodiments, an encoder may signal (or generate) one or more syntax element in a bitstream, such that a decoder may parse said one or more syntax element from the bitstream.

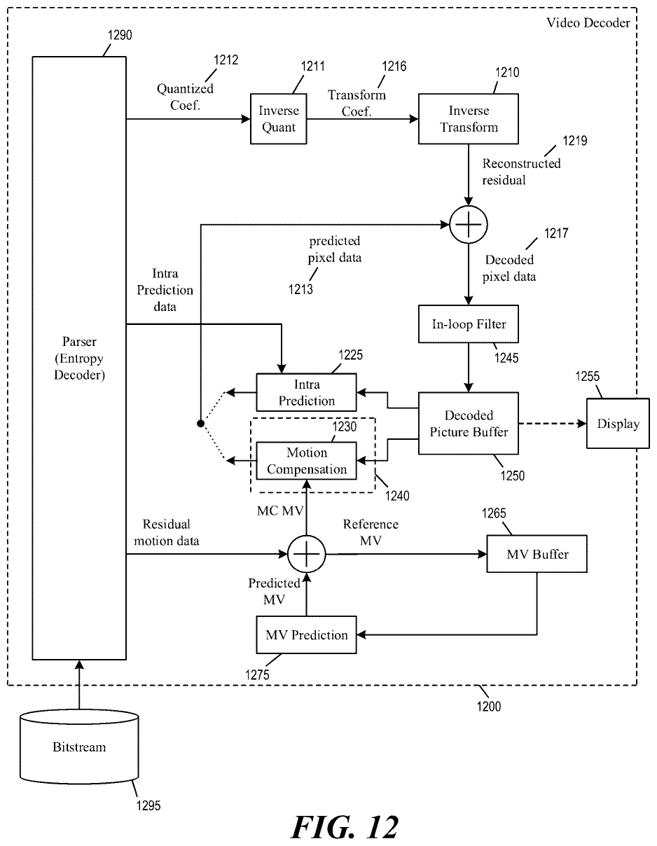

FIG. 12 illustrates an example video decoder 1200 that may refine affine candidates. As illustrated, the video decoder 1200 is an image-decoding or video-decoding circuit that receives a bitstream 1295 and decodes the content of the bitstream into pixel data of video frames for display. The video decoder 1200 has several components or modules for decoding the bitstream 1295, including some components selected from an inverse quantization module 1211, an inverse transform module 1210, an intra-prediction module 1225, a motion compensation module 1230, an in-loop filter 1245, a decoded picture buffer 1250, a MV buffer 1265, a MV prediction module 1275, and a parser 1290. The motion compensation module 1230 is part of an inter-prediction module 1240.

In some embodiments, the modules 1210-1290 are modules of software instructions being executed by one or more processing units (e.g., a processor) of a computing device. In some embodiments, the modules 1210-1290 are modules of hardware circuits implemented by one or more ICs of an electronic apparatus. Though the modules 1210-1290 are illustrated as being separate modules, some of the modules can be combined into a single module.

The parser 1290 (or entropy decoder) receives the bitstream 1295 and performs initial parsing according to the syntax defined by a video-coding or image-coding standard. The parsed syntax element includes various header elements, flags, as well as quantized data (or quantized coefficients) 1212. The parser 1290 parses out the various syntax elements by using entropy-coding techniques such as context-adaptive binary arithmetic coding (CABAC) or Huffman encoding.

The inverse quantization module 1211 de-quantizes the quantized data (or quantized coefficients) 1212 to obtain transform coefficients, and the inverse transform module 1210 performs inverse transform on the transform coefficients 1216 to produce reconstructed residual signal 1219. The reconstructed residual signal 1219 is added with predicted pixel data 1213 from the intra-prediction module 1225 or the motion compensation module 1230 to produce decoded pixel data 1217. The decoded pixels data are filtered by the in-loop filter 1245 and stored in the decoded picture buffer 1250. In some embodiments, the decoded picture buffer 1250 is a storage external to the video decoder 1200. In some embodiments, the decoded picture buffer 1250 is a storage internal to the video decoder 1200.

The intra-prediction module 1225 receives intra-prediction data from bitstream 1295 and according to which, produces the predicted pixel data 1213 from the decoded pixel data 1217 stored in the decoded picture buffer 1250. In some embodiments, the decoded pixel data 1217 is also stored in a line buffer (not illustrated) for intra-picture prediction and spatial MV prediction.

In some embodiments, the content of the decoded picture buffer 1250 is used for display. A display device 1255 either retrieves the content of the decoded picture buffer 1250 for display directly, or retrieves the content of the decoded picture buffer to a display buffer. In some embodiments, the display device receives pixel values from the decoded picture buffer 1250 through a pixel transport.

The motion compensation module 1230 produces predicted pixel data 1213 from the decoded pixel data 1217 stored in the decoded picture buffer 1250 according to motion compensation MVs (MC MVs). These motion compensation MVs are decoded by adding the residual motion data received from the bitstream 1295 with predicted MVs received from the MV prediction module 1275.

The MV prediction module 1275 generates the predicted MVs based on reference MVs that were generated for decoding previous video frames, e.g., the motion compensation MVs that were used to perform motion compensation. The MV prediction module 1275 retrieves the reference MVs of previous video frames from the MV buffer 1265. The video decoder 1200 stores the motion compensation MVs generated for decoding the current video frame in the MV buffer 1265 as reference MVs for producing predicted MVs.

The in-loop filter 1245 performs filtering or smoothing operations on the decoded pixel data 1217 to reduce the artifacts of coding, particularly at boundaries of pixel blocks. In some embodiments, the filtering or smoothing operations performed by the in-loop filter 1245 include deblock filter (DBF), sample adaptive offset (SAO), and/or adaptive loop filter (ALF).

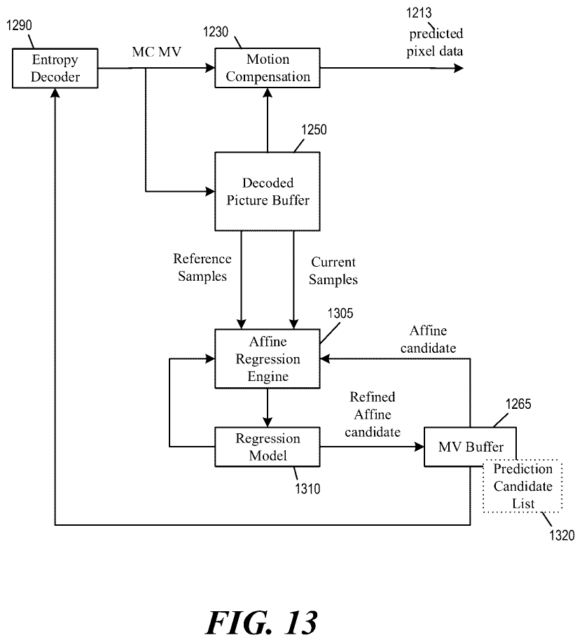

FIG. 13 illustrates portions of the video decoder 1200 that implement affine candidate refinement by regression. As illustrated, the entropy decoder 1290 may provide a selection of a prediction candidate from a prediction candidate list 1320 based on syntax elements signaled in the bitstream 1295. The selected prediction candidate is provided to the motion compensation module 1230 to generate the predicted pixel data for inter-prediction 1213.

The prediction candidates list 1320 may include merge candidates and affine candidate(s). The affine candidates may be affine MMVD candidates and/or affine AMVP candidates and/or affine merge candidates. The prediction candidates of the list 1320 are stored in the MV buffer 1265. Some of the affine candidates in the list may be refined or generated by a regression model 1310.

A regression engine 1305 performs regression to generate the regression model 1310 based on content of the decoded picture buffer 1250 and the MV buffer 1265. The regression model 1310 may be generated by template regression that minimizes a difference between samples of a current template neighboring the current block and samples of a reference template identified by the refined prediction candidate. The regression model 1310 may also be generated by MV regression that minimizes differences between (i) subblock MVs of subblocks neighboring the current block and (ii) subblock MVs derived from an affine candidate of the current block. The regression model may also be a blended model of a first model created by template regression and a second model created by MV regression. In some embodiments, only a subset of the prediction candidates in the list are subject to refinement by the regression model 1310.

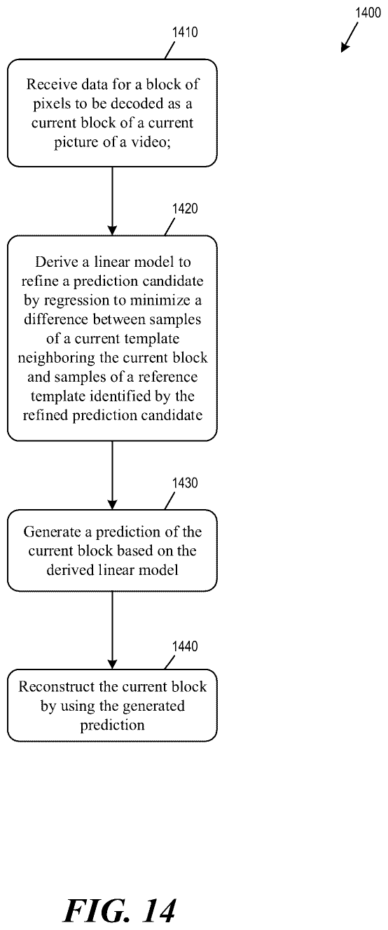

FIG. 14 conceptually illustrates a process 1400 that refines prediction candidates by deriving regression models. In some embodiments, one or more processing units (e.g., a processor) of a computing device implementing the decoder 1200 performs the process 1400 by executing instructions stored in a computer readable medium. In some embodiments, an electronic apparatus implementing the decoder 1200 performs the process 1400.

The decoder receives (at block 1410) data to be decoded as a current block of pixels in a current picture of a video. The decoder derives (at block 1420) a linear model to refine a prediction candidate by regression to minimize a difference between samples of a current template neighboring the current block and samples of a reference template identified by the refined prediction candidate.

In some embodiments, the prediction candidate being refined is an affine motion candidate and the derived linear model is an affine motion model having four parameters for affine motion based on two check points or an affine motion model having six parameters for three check points. The affine motion candidate being refined may be a merge candidate with motion vector difference (MMVD) candidate or an adaptive motion vector prediction (AMVP) candidate. The prediction candidate being refined may also be a regular merge candidate.

In some embodiments, the refined prediction candidate is added to a list of prediction candidates for the current block. In some embodiments, the refined prediction candidate replaces the prediction candidate in a list of prediction candidates for the current block.

In some embodiments, only a subset of prediction candidates in the list of prediction candidates are refined by regression for the linear model. The subset of prediction candidates may be merge mode with motion vector difference (MMVD) candidates that are identified based on proximity to a specific direction. In some embodiments, for each MMVD candidate, only a base motion vector predictor (MVP) is refined by regression.

The decoder generates (at block 1430) a prediction of the current block based on the derived linear model. The prediction may be generated based on the refined prediction candidate. The decoder reconstructs (at block 1440) the current block by using the generated prediction. The decoder may then provide the reconstructed current block for display as part of the reconstructed current picture.

In some embodiments, the derived model is an affine motion model that is derived by minimizing a difference between regression subblock motion vectors and (i) subblock MVs of subblocks neighboring the current block and (ii) subblock MVs derived from an affine candidate of the current block to refine the affine candidate. The prediction is generated based on the refined affine candidate. In some embodiments, the affine motion model is derived by minimizing differences between the regression subblock motion vectors and (i) stored subblock MVs associated with subblocks neighboring the current block and (ii) inherited MVs associated with subblocks belonging to a reference affine coding unit (CU). The reference affine CU may not be adjacent to the current block.

### IX. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

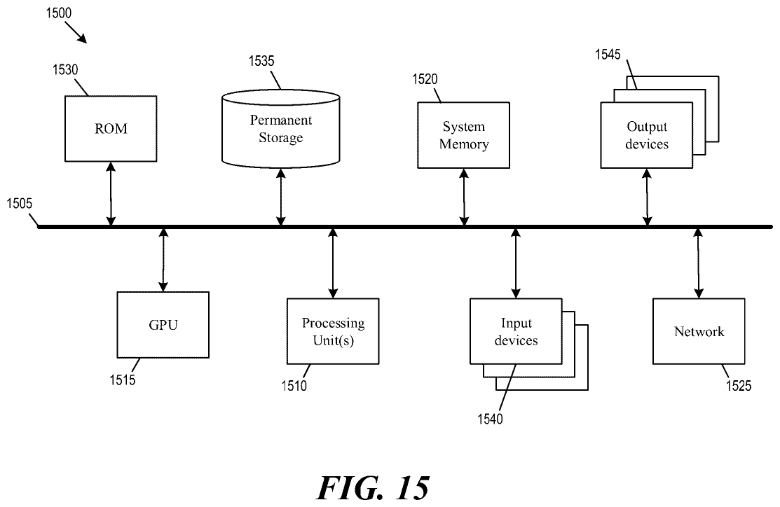

FIG. 15 conceptually illustrates an electronic system 1500 with which some embodiments of the present disclosure are implemented. The electronic system 1500 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1500 includes a bus 1505, processing unit(s) 1510, a graphics-processing unit (GPU) 1515, a system memory 1520, a network 1525, a read-only memory 1530, a permanent storage device 1535, input devices 1540, and output devices 1545.

The bus 1505 collectively represents all system, peripheral, and chipset buses that communicatively connect the numerous internal devices of the electronic system 1500. For instance, the bus 1505 communicatively connects the processing unit(s) 1510 with the GPU 1515, the read-only memory 1530, the system memory 1520, and the permanent storage device 1535.

From these various memory units, the processing unit(s) 1510 retrieves instructions to execute and data to process in order to execute the processes of the present disclosure. The processing unit(s) may be a single processor or a multi-core processor in different embodiments. Some instructions are passed to and executed by the GPU 1515. The GPU 1515 can offload various computations or complement the image processing provided by the processing unit(s) 1510.

The read-only-memory (ROM) 1530 stores static data and instructions that are used by the processing unit(s) 1510 and other modules of the electronic system. The permanent storage device 1535, on the other hand, is a read-and-write memory device. This device is a non-volatile memory unit that stores instructions and data even when the electronic system 1500 is off. Some embodiments of the present disclosure use a mass-storage device (such as a magnetic or optical disk and its corresponding disk drive) as the permanent storage device 1535.

Other embodiments use a removable storage device (such as a floppy disk, flash memory device, etc., and its corresponding disk drive) as the permanent storage device. Like the permanent storage device 1535, the system memory 1520 is a read-and-write memory device. However, unlike storage device 1535, the system memory 1520 is a volatile read-and-write memory, such a random access memory. The system memory 1520 stores some of the instructions and data that the processor uses at runtime. In some embodiments, processes in accordance with the present disclosure are stored in the system memory 1520, the permanent storage device 1535, and/or the read-only memory 1530. For example, the various memory units include instructions for processing multimedia clips in accordance with some embodiments. From these various memory units, the processing unit(s) 1510 retrieves instructions to execute and data to process in order to execute the processes of some embodiments.

The bus 1505 also connects to the input and output devices 1540 and 1545. The input devices 1540 enable the user to communicate information and select commands to the electronic system. The input devices 1540 include alphanumeric keyboards and pointing devices (also called “cursor control devices”), cameras (e.g., webcams), microphones or similar devices for receiving voice commands, etc. The output devices 1545 display images generated by the electronic system or otherwise output data. The output devices 1545 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 15, bus 1505 also couples electronic system 1500 to a network 1525 through a network adapter (not shown). In this manner, the computer can be a part of a network of computers (such as a local area network (“LAN”), a wide area network (“WAN”), or an Intranet, or a network of networks, such as the Internet. Any or all components of electronic system 1500 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 11 and FIG. 14) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A video coding method comprising:
receiving data for a block of pixels to be encoded or decoded as a current block of a current picture of a video;
deriving a linear model to refine or generate a prediction candidate by regression to minimize a difference between samples of a current template neighboring the current block and samples of a reference template identified by the prediction candidate;
generating a prediction of the current block based on the derived linear model; and
encoding or decoding the current block by using the generated prediction.

2. The video coding method of claim 1, wherein the derived prediction candidate being refined is an affine motion candidate and the derived model is an affine motion model having four parameters for affine motion based on two check points or an affine motion model having six parameters for three check points.

3. The video coding method of claim 2, wherein the affine motion candidate being refined is a merge candidate with motion vector difference (MMVD) candidate or an adaptive motion vector prediction (AMVP) candidate.

4. The video coding method of claim 1, wherein the refined prediction candidate is added to a list of prediction candidates for the current block.

5. The video coding method of claim 1, wherein the refined prediction candidate replaces the prediction candidate in a list of prediction candidates for the current block.

6. The video coding method of claim 1, wherein only a subset of prediction candidates in a list of prediction candidates for the current block are refined by regression for the linear model.

7. The video coding method of claim 6, wherein the subset of prediction candidates are merge mode with motion vector difference (MMVD) candidates that are identified based on proximity to a specific direction.

8. The video coding method of claim 6, wherein for each MMVD candidate, only a base motion vector predictor (MVP) is refined by regression.

9. The video coding method of claim 1, wherein the prediction is generated based on the refined prediction candidate.

10. The video coding method of claim 1, wherein the prediction candidate being refined is a regular merge candidate.

11. The video coding method of claim 1, wherein:
the derived model is an affine motion model that is derived by minimizing a difference between regression subblock motion vectors and (i) subblock MVs of subblocks neighboring the current block and (ii) subblock MVs derived from an affine candidate of the current block to refine the affine candidate; and
the prediction is generated based on the refined affine candidate.

12. The video coding method of claim 11, wherein the affine motion model is derived by minimizing differences between the regression subblock motion vectors and (i) stored subblock MVs associated with subblocks neighboring the current block and (ii) inherited MVs associated with subblocks belonging to a reference affine coding unit (CU).

13. The video coding method of claim 12, wherein the reference affine CU is not adjacent to the current block.

14. A video coding method comprising:
receiving data for a block of pixels to be encoded or decoded as a current block of a current picture of a video;
deriving a linear model to refine an affine candidate by regression to minimize a difference between regression subblock motion vectors and (i) subblock MVs of subblocks neighboring the current block and (ii) subblock MVs derived from the refined affine candidate of the current block;
generating a prediction of the current block based on the derived linear model; and
encoding or decoding the current block by using the generated prediction.

15. An electronic apparatus comprising:
a video decoder circuit configured to perform operations comprising:
receiving data for a block of pixels to be encoded or decoded as a current block of a current picture of a video;
deriving a linear model to refine or generate a prediction candidate by regression to minimize a difference between samples of a current template neighboring the current block and samples of a reference template identified by the prediction candidate;
generating a prediction of the current block based on the derived linear model; and
encoding or decoding the current block by using the generated prediction.

16. (canceled)

17. (canceled)
